(19) United States
(12) Patent Application Publication
(10) Pub. No.: US 2017/0233236 A1
(43) Pub. Date: Aug. 17, 2017

(54) Manual Water Bottle Connection System for Bottom Load Water Coolers

(71) Applicant: Xiao Shen, Minneapolis, MN (US)

(72) Inventor: Xiao Shen, Minneapolis, MN (US)

(21) Appl. No.: 15/408,406

(22) Filed: Jan. 17, 2017

Related U.S. Application Data
(60) Provisional application No. 62/287,886, filed on Jan. 27, 2016.

(51) Int. Cl. B67D 1/08; F25D 31/00; B67D 1/00

(52) U.S. Cl. CPC B67D 1/0841; B67D 1/0004; B67D 1/0855; F25D 31/002

(57) ABSTRACT

A system which allows easy manual connection of the water bottle of a water cooler, with its bottle placed in an upright position at the bottom of the cooler (bottom load water cooler), to the remaining water system of the said water cooler and the related bottom load water cooler system. With the said system, connecting or disconnecting the water bottle of such water cooler system is a task as simple as manually turning a rotational handle clockwise or counter clockwise. This allows replacing the water bottle of such water cooler without touching any of its water pipes, which not only simplifies the process, but more importantly also eliminates chance of contamination of the drinking water system during the process. The system further utilizes a universal water bottle sealing cap with air filters to suppress bacteria growth in the drinking water bottle due to intake of polluted air. A reversible pressing system allows automatically adjustment for water bottles of different height and allows using the same type of water bottle as those used on conventional water cooler with its water bottle sitting on top of it in an inverted position (top load water cooler). All these features make it simpler and safer to enjoy the benefit brought by the bottom load water cooler system and bring the hygiene standard of such system to a higher level.

### TECHNICAL FIELD

The present invention pertains generally to bottled water coolers, and more particularly to a system which allows easy manual connection between the water bottle of a bottom load water cooler, with its bottle placed in an upright position at the bottom of the cooler, and the remaining water system of the said water cooler, as well as the related bottom load water cooler system.

### BACKGROUND OF THE INVENTION

Water cooler systems which allow water bottle to be placed on the floor rather than on top of the water cooler in an inverted position are well known in the art. Examples of these systems include U.S. Pat. No. 3,495,612 issued Feb. 17, 1970, U.S. Pat No. 3,584,472 issued Jun. 15, 1971, U.S. Pat No. 5,495,725 issued Mar. 5, 1996 and U.S. Pat No. 6,793,099 issued Sep. 21, 2004. Although advantage of such systems is obvious, a common disadvantage of the current bottom loading water cooler systems on the market is that the process of replacing the water bottle involves touching the water pipes with human hands which arises an hygiene issue. More so, due to the lack of air filtration system, unfiltered air from the outer environment is introduced into the water bottle whenever water is pumped out of the bottle, leading to rapid growth of bacteria inside the water bottle. The fixed connection between the water pipe and the water cooler also prevents easy disassembly, cleaning and sanitizing of the water pipe. Current systems also require a special type of water bottle that is different from the type of bottle used for the more conventional top loading water cooler which positions the water bottle in a top down position at the top of the cooler. It would be desirable if a new system could realize easy connection when replacing water bottles, reduce contamination to the water system during the process and allow use of the same kind of water bottle for both top loading and bottom loading water cooler systems.

### SUMMARY OF THE INVENTION

The present invention is directed mainly to a system which allows easy manual connection of the water bottle of a bottom load water cooler to the remaining water system of the said water cooler and the related bottom load water cooler system. It has a simple structure that can automatically compensate for water bottles of different height, making connecting/disconnecting water bottle as simple as turning a handle clockwise/counter clockwise without touching any of the water pipes and thus making water bottom replacement not only much easier, but also more hygienic. The connection assembly also includes a set of air filters to further sanitize the environment inside the drinking water bottle for even more improved drinking water safety.

The said system comprises a reversible pressing assembly, a sealing cap assembly, a rotational handle assembly and a height adjusting water pipe. The said reversible pressing assembly comprises a height adjusting housing, reversing springs, a reversing spring cap and a rotational handle cap. The said height adjusting housing has an upper chamber and a bottom chamber and sits on top of the middle partition plate of the water cooler. The bottom ends of the said reversing springs are attached to the top of the said handle cap and both reside in the upper chamber of the said height adjusting housing. The said reversing spring cap is mounted on top of the height adjusting housing and connects to the top ends of the said reversing springs. The said rotational handle assembly comprises an upper cylinder and a diagonal cut half cylinder (handle assembly half cylinder) with a handle attached to it. The said rotational handle upper cylinder resides in the bottom chamber of the height adjusting housing and is connected to the said rotational handle cap. The said height adjusting water pipe spans through the center of the said height adjusting housing and the said rotational handle assembly. Its bottom is attached to another diagonal cut half cylinder (water pipe half cylinder) and a male screw thread adapter. The said sealing cap assembly comprises a sealing cap with female threaded central hole, water seal gasket ring, air seal gasket ring and air filters. The said sealing cap threads on to the end of the said height adjusting water pipe. The said water seal gasket ring sits in the central hole of the said sealing cap and is attached to the end of the said water pipe. The said air seal gasket ring is surrounds the said water seal gasket ring. The air filter is placed at the top of the said sealing cap and in between the water seal gasket ring and the air seal gasket ring.

In a preferred embodiment of the present invention, at the top of the said height adjusting water pipe, there are resetting springs and a spring stopper. The bottoms of the resetting springs attach to the said reversing spring cap and the top of the resetting spring are attached to the said spring stopper. The handle of the said rotational handle assembly is attached to side and close to the bottom of the handle assembly half cylinder, of which the diagonal cutting surface is facing down in the assembly. The handle assembly half cylinder sits on top of the water pipe half cylinder, of which the diagonal cut surface is facing up and matches the down facing diagonal cutting surface of the handle assembly half cylinder. The present invention also involves a bottom load water cooler system which works together with the above mentioned water bottle connection system, which includes a water cooler body, a water reservoir, a pump system, any of the afore mentioned water bottle connection system, a water bottle, a water supply pipe, a water supply pipe cap, and a water supply head assembly. The said water cooler body is divided into an upper chamber, a middle chamber and a bottom chamber. The said water reservoir sits in the said upper chamber. The aforementioned water bottle connection assembly sits in the said middle chamber. The said water bottle sits in the said bottom chamber. The outlet of the said pump connects to the said water reservoir through a water pipe. The inlet of the said pump connects to the upper end of the aforementioned height adjusting water pipe of the water bottle connection assembly. The said water supply pipe sits in the water bottle. Its bottom end connects to the said water supply head assembly and its top end is welded to the said water supply pipe cap which covers the top of the water bottle.

When the said water bottle connection assembly moves down (by turning the handle) and connects to the said water supply cap, the bottom of the height adjusting water pipe automatically connects to the said water supply pipe.

In accordance with a preferred embodiment of the invention, an air return pipe, a water flow sensor and a water level control float are provided. One end of the air return pipe connects to air in the said water reservoir and its other end connects to the air return port of the said sealing cap. The water flow sensor connects to the pipe between the said pump and the said water reservoir. The water level float shutoff valve is installed in the said water reservoir.

In accordance with a preferred embodiment of the invention, the said water supply cap has a hole in its center for connecting the said water supply pipe and a few air inlet holes around it.

In accordance with a preferred embodiment of the invention, the said water supply pipe is ‘S’ shaped.

In accordance with a preferred embodiment of the invention, the said water supply head assembly comprises a flex tube, a stopper pin, a stopper ring, an o-ring and a sucking head. The said water supply pipe's bottom end is capped by the said flex tube with the said sucking head installed at the bottom of the flex tube. The said stopper ring, stopper pin and o-ring are installed at the top end of the said flex tube.

### BRIEF DESCRIPTION OF THE DRAWINGS

FIG. 1 is an enlarged sectional view of the water bottle connection system.

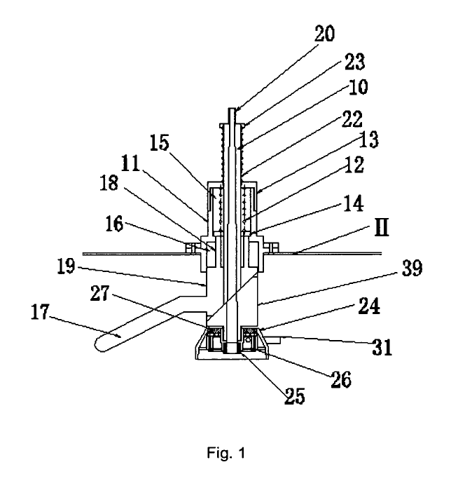

FIG. 2 is a sectional view of the bottom load water cooler with the water bottle connection system at a disconnected state.

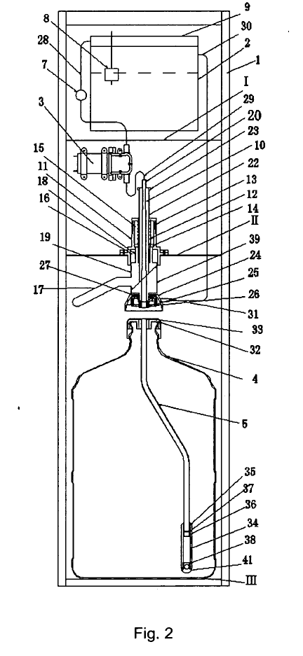

FIG. 3 is a sectional view of the bottom load water cooler with the water bottle connection system at a connected state.

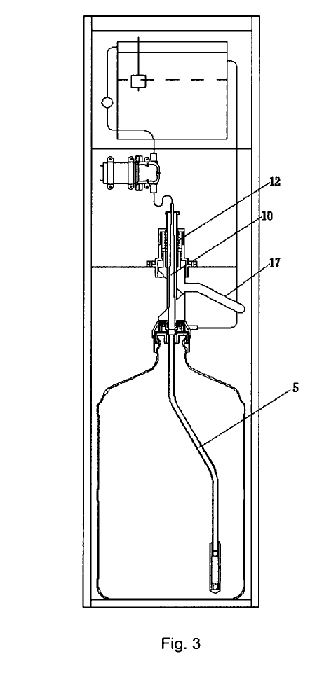

### DETAILED DESCRIPTION OF PREFERRED EMBODIMENTS

Please refer to the figures for numeral reference of the components.

The present invention proposed a bottom load water cooler with a manual water bottle connection system. It includes: water cooler body (1), water reservoir (2), pump (3), water bottle (4), water supply pipe (5), water supply cap (6), water supply head assembly (34-38, 40), water flow sensor (7), water level float shutoff (8) and the said manual water bottle connection system. The water cooler body (1) is divided into an upper chamber, a middle chamber and a bottom chamber. The water reservoir (2) sits in the upper chamber. The water bottle connection assembly sits in the middle chamber on the water cooler's middle partition plate. The water bottle (4) sits in the bottom chamber.

The manual water bottle connection system comprises a reversible pressing assembly, a sealing cap assembly, a rotational handle assembly and a height adjusting water pipe (10). The reversible pressing assembly comprises a height adjusting housing (11), reversing springs (12), a reversing spring cap (13) and a handle cap (14). The height adjusting housing (11) is the main frame of the entire manual connection system and is mounted on the middle partitioning plate of the water cooler using bolts. It is a hollow structure with an upper chamber (15) and a bottom chamber (16). The reversing springs (12) are mounted on top of the handle cap (14) inside the upper chamber (16) of the height adjusting housing (11). The reversing spring cap (13) sits on top of the reversing springs (12) ad is screwed on top of the upper chamber (15) if the height adjusting housing (11).

The rotational handle assembly comprises an upper cylinder (18) and a diagonal cut half cylinder (handle assembly half cylinder) (19) with a handle (17) attached to it. The upper cylinder (18) resides in the bottom chamber (16) of the height adjusting housing (11) and is screwed on to the handle cap (14). The handle cap is a round plate with grooved female threads at its center that matches the threads on the handle assembly upper cylinder (18). Its function is to limit the handle assembly's position and transfer the pressure from the reversing springs (12) to the handle assembly half cylinder (19).

The height adjusting water pipe (10) has a square cross section with its bottom inserted into the water pipe half cylinder (39). Its top is the water outlet (2) connecting to the pump (3). Its bottom is a male screw thread adapter used for connection with the sealing cap. The water pipe half cylinder has a right angle cut on its long surface for position limit. The height adjusting water pipe (10) spans through the center of the height adjusting housing (11) and the rotational handle assembly. The diagonal cut surface of the water pipe half cylinder (39) matches the diagonal cut surface of the handle assembly half cylinder (19). At the top of the height adjusting water pipe (10), there are resetting springs (22) and a spring stopper (23), The bottom of the resetting springs (22) connect to the reversing spring cap (13) and the spring stopper (23) sits on top of the reversing springs (22). When the handle assembly half cylinder (19) rotates to the right, the height adjusting water pipe (10) moves downward due to the diagonal cut surface of the cylinder. When the handle moves to the left, the height adjusting water pipe (10) moves upward due to the lifting force from the resetting springs (22).

The said sealing cap assembly comprises a sealing cap with female threaded central hole (24), water seal gasket ring (25), air seal gasket ring (26) and air filters (27). The said sealing cap threads on to the end of height adjusting water pipe (10) through its male thread adapter. The water seal gasket ring (25) sits in the central hole of the sealing cap (24) and is attached to the end of the height adjusting water pipe (10). The air seal gasket ring (26) surrounds the said water seal gasket ring (25). The air filter (27) is placed at the top of the sealing cap (24) and in between the water seal gasket ring and the air seal gasket ring.

The water reservoir (2) has a lid (9). Inside the reservoir (2) is a water level control float (8). When the water level in the reservoir (2) is low, the water level control float (8) sends a signal to the pump (3) to start pumping water. When the water level in the reservoir (2) is high, the water level control float (8) sends a signal to stop the pump (3). When the pump (3) is pumping water, the water flow sensor (7) senses the water flow and would send a warning and signal to stop the pump (3) if it can't sense water flow in a certain time period, indicating either low water level in the water bottle or a pump (3) failure.

The outlet of the pump (3) connects to the water inlet (28) of the reservoir (2). Its inlet connects to the height adjusting water pipe through a flex hose (29). The water flow sensor is installed in between the pump (3) and the water reservoir (2).

The air return system includes the air return pipe (30) and the air return port (31) on the sealing cap of the manual water bottle connection system, which connects to one end of the air return pipe, of which the other end connects to the upper air in the said water reservoir.

The said water bottle (4) has a cap (32), outside of which sits the water supply cap (33). The said water supply cap has a hole in its center for connecting the said water supply pipe and a few air inlet holes around it. The said water supply pipe is designed to have an “S” shape to avoid interference with the protruded flat at the central bottom of the water bottle. One end of the water supply pipe is welded to the central hole of the said water supply cap and the other end connects to the said water supply head assembly. The said water supply head assembly comprises a flex tube (34), a stopper pin (37), a stopper ring (36), an o-ring (35) and a sucking head (38). The top end of the said flex tube (34) is connected to the end of the said water supply pipe (5) and the bottom end connects to the said sucking head (38). The said stopper ring, stopper pin and o-ring are installed at the top end of the said flex tube. The water supply head assembly serves two functions: one is to automatically adjust the sucking head's position in accordance with the water bottle height; the other is to lock the insert of the water bottle cap on it when the water supply pipe is inserted into the water bottle and automatically return the insert to the water bottle cap (to seal the water bottle) when the water supply pipe is removed from the water bottle.

When the water bottle connection assembly moves downwards and connects the said height adjusting pipe with the said water supply pipe, the water and air way of the entire system is connected.

The main function of the said reversible pressing assembly is to adjust for different water bottle height such that the pressure between the sealing cap and the water supply cap is always maintained at a proper level: not too loose to cause leaking in the water and air way of the system, nor too tight to cause damage to the connection system. When the handle is rotated to the right, at first, the handle assembly moves downwards and by ˜90 degree, the sealing cap should be in touch with the water bottle cap. When the handle is rotated further, the handle assembly starts to move upward instead due to the force from the water bottle. In this process, the reversing springs are compressed and provide the pressure for a tight connection between the sealing cap and the water bottle cap.

Above is just a preferred embodiment of the invention and should not be used to limit the scope of the patent. Any equivalent structure based on this patent and the drawings, used either directly or indirectly in other related technical fields, should all be covered by this patent.

1. I claim a manual water bottle connection system for bottom load water coolers: The said system comprises a reversible pressing assembly, a sealing cap assembly, a rotational handle assembly and a height adjusting water pipe. The said reversible pressing assembly comprises a height adjusting housing, reversing springs, a reversing spring cap and a rotational handle cap. The said height adjusting housing has an upper chamber and a bottom chamber and sits on top of the middle partition plate of the water cooler. The said reversing springs sit on top of the rotational handle cap inside the said upper chamber. Its top is capped by the said reversing spring cap which is fixed on the upper chamber. The said rotational handle assembly comprises an upper cylinder and a diagonal cut half cylinder (handle assembly half cylinder) with a handle attached to it. The said rotational handle upper cylinder resides in the bottom chamber of the height adjusting housing and is connected to the said rotational handle cap. The said height adjusting water pipe spans through the center of the said height adjusting housing and the said rotational handle assembly. Its bottom is attached to another diagonal cut half cylinder (water pipe half cylinder) and a male screw thread adapter. The said sealing cap assembly comprises a sealing cap with female threaded central hole, water seal gasket ring, air seal gasket ring and air filters. The said sealing cap threads on to the end of the said height adjusting water pipe. The said water seal gasket ring sits in the central hole of the said sealing cap and is attached to the end of the said water pipe. The said air seal gasket ring is surrounds the said water seal gasket ring. The air filter is placed at the top of the said sealing cap and in between the water seal gasket ring and the air seal gasket ring.

2. I claim a manual water bottle connection system for bottom load water cooler based on claim 1. A set of resetting springs and a spring stopper are installed on top of the said height adjusting water pipe. The bottoms of the resetting springs attach to the said reversing spring cap and the top of the resetting spring are attached to the said spring stopper.

3. I claim a manual water bottle connection system for bottom load water cooler based on claim 1. The bottom surface of the said handle assembly half cylinder is a diagonal cut surface. The said handle is attached to the lower bottom of the side of the said handle assembly half cylinder near the bottom of the diagonal cut surface.

4. I claim a manual water bottle connection system for bottom load water cooler based on claim 1. The diagonal cut surface of the said handle assembly half cylinder matches the diagonal cut surface of the said water pipe half cylinder.

5. I claim a bottom load water cooler system which works together with the above mentioned water bottle connection system. It includes a water cooler body, a water reservoir, a pump system, any of the water bottle connection devices described in claims 1-4, a water bottle, a water supply pipe, a water supply pipe cap, and a water supply head assembly. The said water cooler body is divided into an upper chamber, a middle chamber and a bottom chamber. The said water reservoir sits in the said upper chamber. The aforementioned water bottle connection assembly sits in the said middle chamber. The said water bottle sits in the said bottom chamber. The outlet of the said pump connects to the said water reservoir through a water pipe. The inlet of the said pump connects to the upper end of the aforementioned height adjusting water pipe of the water bottle connection assembly. The said water supply pipe is inserted into the water bottle. Its bottom end connects to the said water supply head assembly and its top end is welded to the said water supply pipe cap which covers the top of the water bottle. When the said water bottle connection assembly moves down, it connects to the said water supply cap such that the bottom of the height adjusting water pipe automatically connects to the said water supply pipe.

6. I claim a bottom load water cooler system with the aforementioned manual water bottle connection system based on claim 5. The water cooler system also includes an air return pipe, a water flow sensor and a water level control float. One end of the air return pipe connects to air in the said water reservoir and its other end connects to the air return port of the said sealing cap. The water flow sensor connects to the pipe between the said pump and the said water reservoir. The water level float shutoff valve is installed in the said water reservoir.

7. I claim a bottom load water cooler system with the aforementioned manual water bottle connection system based on claim 5. The said water supply cap has a hole in its center for connecting the said water supply pipe and a few air inlet holes around it.

8. I claim a bottom load water cooler system with the aforementioned manual water bottle connection system based on claim 5. The said water supply pipe is ‘S’ shaped.

9. I claim a bottom load water cooler system with the aforementioned manual water bottle connection system based on claim 5. The said water supply head assembly comprises a flex tube, a stopper pin, a stopper ring, an o-ring and a sucking head. The said water supply pipe's bottom end is capped by the said flex tube with the said sucking head installed at the bottom of the flex tube. The said stopper ring, stopper pin and o-ring are installed at the top end of the said flex tube.
